(19) United States
(12) Patent Application Publication
(10) Pub. No.: US 2018/0114194 A1
(43) Pub. Date: Apr. 26, 2018

(54) AUTOMATIC TIME BLOCKING FOR CALENDAR APPLICATIONS

(71) Applicant: Microsoft Technology Licensing, LLC, Redmond, WA (US)

(72) Inventors: Shawn J. Tabrizi, Redmond, WA (US); Shiv D. Bijlani, Seattle, WA (US)

(21) Appl. No.: 15/333,168

(22) Filed: Oct. 24, 2016

(51) Int. Cl. G06Q 10/10; G06F 3/0484; G06F 3/0482

(52) U.S. Cl. CPC G06Q 10/1095; G06F 3/0482; G06F 3/04847

(57) ABSTRACT

An automatic time blocking service can receive information identifying a user calendar and a user setting at least regarding an amount of time for an event type within a time period; set a threshold according to the user settings; monitor the user calendar, via communication with a calendar service, to determine whether the time period in the user calendar has characteristics satisfying the threshold; and upon determining that the time period in the user calendar has characteristics satisfying the threshold, automatically, without user interaction, request the calendar service to modify the user calendar.

### BACKGROUND

Often, individuals have so many meetings on their calendar that they are unable to get productive work done. The number of meetings a person has can depend on role or position in a company. Individuals may have certain preferences on when they would like to meet and how long they would like to be in meetings. In addition, individuals may prefer to keep long chunks of time available to work and to minimize the number of short periods of dead space within their calendar.

### BRIEF SUMMARY

Automatic time blocking for calendar applications is described. An automatic time blocking service is provided that supports user productivity. The automatic time blocking service can support user productivity by communicating with a calendar application and a calendar service to monitor and change calendar information for users.

The service can receive information identifying a user calendar and a user setting at least regarding an amount of time for an event type within a time period; set a threshold according to the user settings; monitor the user calendar, via communication with a calendar service, to determine whether the time period in the user calendar has characteristics satisfying the threshold; and upon determining that the time period in the user calendar has characteristics satisfying the threshold, automatically, without user interaction, request the calendar service to modify the user calendar.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an operating environment in which implementations of the described automatic time blocking may be carried out.

FIGS. 2A and 2B illustrate operation of an automatic time blocking service.

FIG. 3 illustrates an example storage structure.

FIGS. 4A-4F provide a series of representative views of a graphical user interfaces for email and calendar applications illustrating an example scenario where an automatic time blocking feature is activated.

FIGS. 5A-5D provide a series of representative views of a graphical user interfaces for email and calendar applications illustrating an example scenario where another automatic time blocking feature is activated.

FIGS. 6A and 6B present block diagrams illustrating components of systems that may be used to implement the techniques described herein.

FIG. 7 illustrates an example system architecture in which the described systems and techniques may be carried out.

### DETAILED DESCRIPTION

Automatic time blocking for calendar applications is described. An automatic time blocking service is provided that supports user productivity. The automatic time blocking service can support user productivity by communicating with a calendar application and a calendar service to monitor and change calendar information for users.

When sharing a calendar to allow other people to schedule meetings, it can be desirable to block out time to accomplish personal tasks. However, when a time period is blocked out as busy on a user's calendar, other users can have difficulty finding available time to schedule a meeting without specifically requesting the user with the blocked out time whether they can meet at a time indicated as busy. The systems and services for automatic time blocking for calendar applications allow a user's calendar to remain open for scheduling on a particular day until a threshold is met, which gives a user the time—without distractions of a meeting or other event—that the user wants for themselves to accomplish their own tasks.

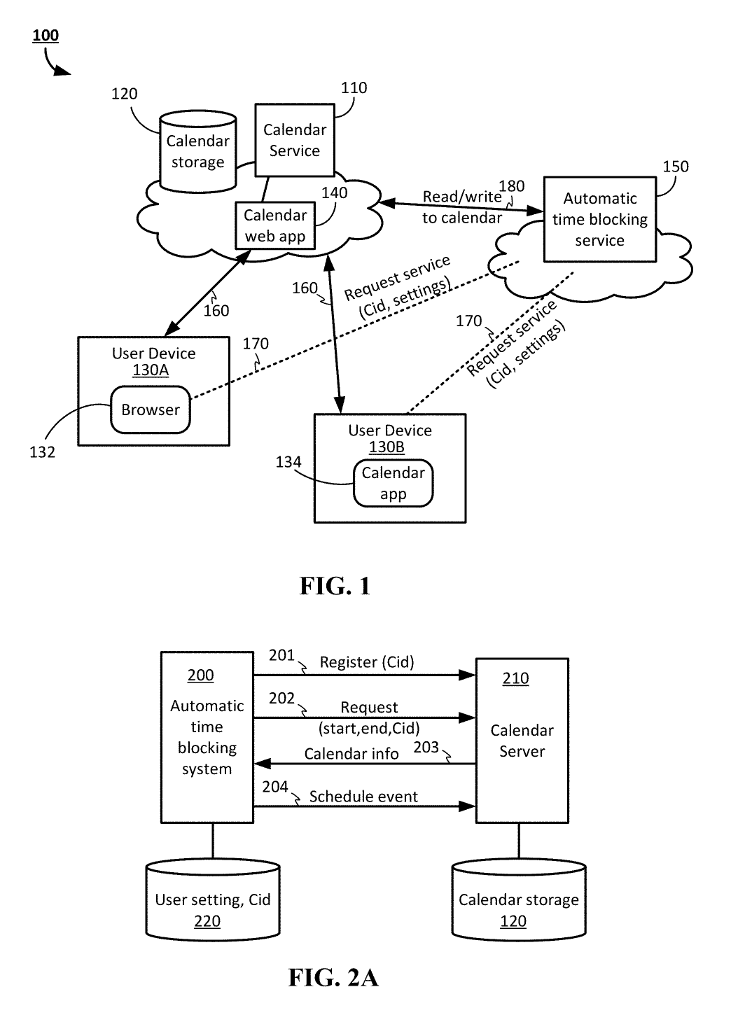

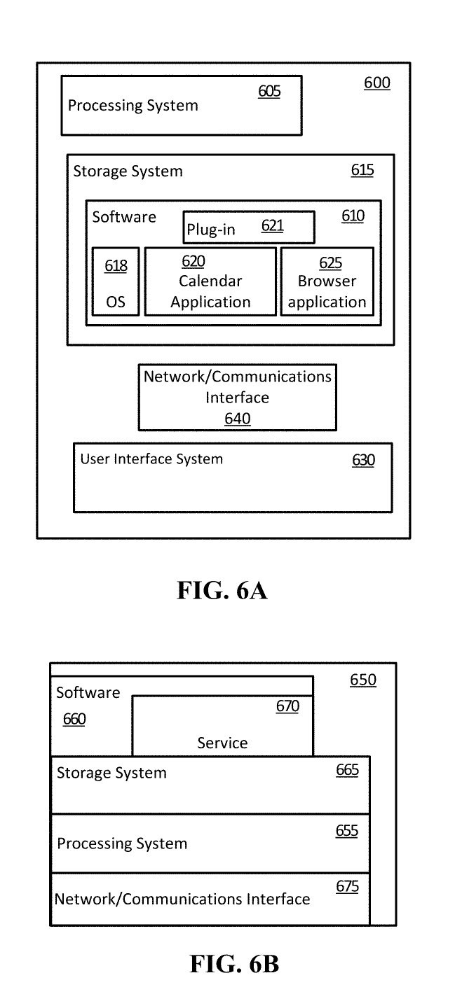

FIG. 1 illustrates an operating environment in which implementations of the described automatic time blocking may be carried out. Referring to FIG. 1, an operating environment 100 for automatic time blocking can involve a calendar service 110 (operating on one or more computing systems which may be embodied as system 650 described with respect to FIG. 6B); a calendar storage 120 (which can include one or more storage resources that may be managed by the calendar service 110); a user computing device 130A on which a user accesses a calendar web-based application 140 via, for example, a browser application 132; or user computing device 130B on which a user accesses their calendars via a calendar application 132, which may be a stand-alone calendar application or part of an information management application and/or email application (user computing devices 130A, 130B being embodied, for example, as described with respect to system 600 of FIG. 6A; and an automatic time blocking service 150 (operating on one or more computing systems being embodied, for example, as described with respect to system 650 of FIG. 6B) that supports an automatic time blocking feature.

A calendar application may include components that are local (at a user's device) and components that are residing on a server, which can provide access and syncing of calendar items across multiple devices and/or storage of the user's calendar items (e.g., via wired and/or wireless communication 160 over a network). In some cases, the calendar application is part of a larger personal information management service that forms a coordinated storage system for more than one user. In various implementations, the calendar application may be a rich client on a desktop or laptop (e.g., Microsoft Outlook®), a mobile client on a mobile device (e.g., a calendar application on the Android OS®, iCal for iOS®, Outlook® for Windows Phone®, or Cal from Any.do), or part of an application running as cloud services accessible via a web browser (e.g., Google® Calendar, Microsoft® Outlook Web App (OWA)).

The automatic time blocking feature can be a feature of a calendar application (or email application) or may be a plug-in or stand-alone application obtained, for example, via an app store. When the automatic time blocking feature is first accessed by a user (e.g., by selecting an icon representing the feature), the user may be directed to sign in for the service, for example, via a browser (such as browser 132), which can allow the user to approve consent for the time blocking feature to access the user's calendar. The set up for the service allows a user to convey and record their general calendar preferences. For example, from within the browser or other front end for the automatic time blocking feature, the user can indicate their preferences. In some cases, advanced options may be available, such as regarding how to handle conflicts within a calendar or different states within an appointment. The request 170 to start the automatic time blocking feature can be communicated to the automatic time blocking service and include a calendar identifier (Cid) and at least one setting regarding user preferences for the service 150. With the user's permission, the service 150 can thus communicate 180 with the calendar service 110 to read and write to the user's calendar identified by the calendar identifier.

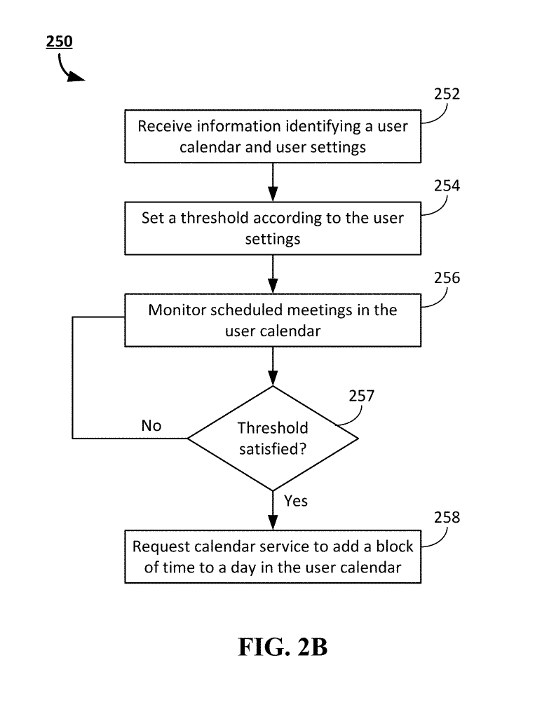

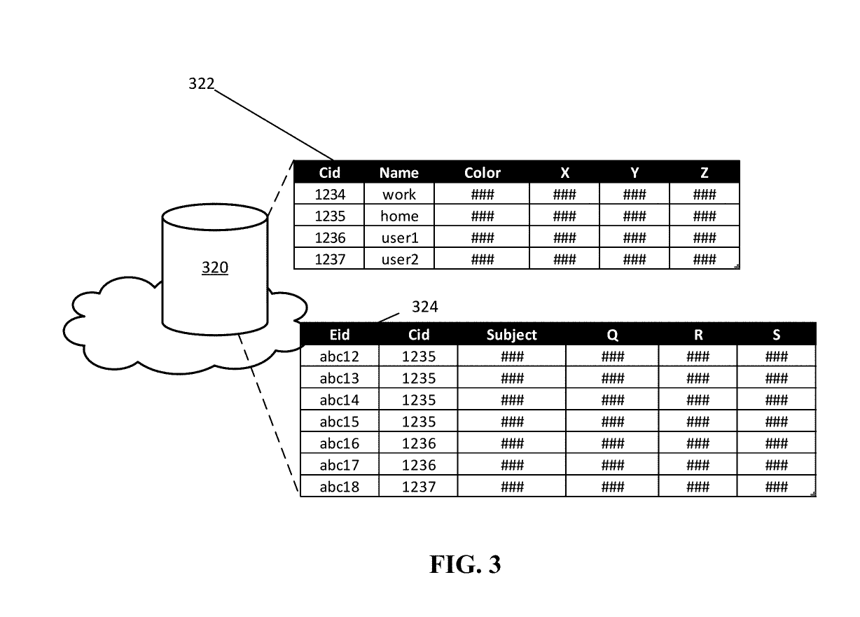

FIGS. 2A and 2B illustrate operation of an automatic time blocking service; and FIG. 3 illustrates an example calendar storage structure.

Referring to FIG. 1 and FIGS. 2A and 2B, an automatic time blocking system 200 can operate an automatic time blocking service 150 (carrying out processes 250) and communicate with a calendar server 210 operating calendar service 110. The automatic time blocking service 150 can receive (252) information identifying a user calendar and a user setting at least regarding an amount of time for an event type within a time period (e.g., via request 170). The time period can be a day, a 24-hour period (spanning one or more days), a work day (e.g., between the hours of 8 am to 6 pm on one of Monday to Friday), a week, or other specified or default period of time. In many instances, the time period is a work day. In some cases, the event type of interest can be a meeting item—an appointment with or without other attendees. In some cases, the event type of interest is the block of contiguous time without a meeting item. The user preferences (e.g., user setting(s) and calendar identifier(s)) can be stored in a data resource 220 associated with the automatic time blocking system 200.

The system 200 sets (254) a threshold according to the user settings. This threshold may also be stored in the data resource 220. In some cases, the threshold is based upon the number of hours of meetings in the time period. For example, the threshold can indicate the maximum number of hours (or minutes) of meetings that the user would like to have scheduled on a particular day. In some cases, the threshold is based upon having a minimum contiguous block of time on a day. For example, the threshold can indicate a desire for a minimum of a 150 minute (2.5 hour) contiguous block of time to remain available on a day.

The system 200 monitors (256) the user calendar, via communication (e.g., 180) with the calendar server 210, to determine (257) whether the time period in the user calendar has characteristics satisfying the threshold. The system 200 may, in some cases, determine whether the time period in the user calendar has characteristics satisfying the threshold by calculating a total number of hours of meeting items in that day and determining whether the total number of hours of meeting items in that day satisfy the threshold of total amount of time for meetings in the time period. In some other cases, the system 200 may, determine whether the time period in the user calendar has characteristics satisfying the threshold by identifying whether there is a block of contiguous time without a meeting item that satisfies a length of time for the block of contiguous time without the meeting item, depending on the user settings.

In some cases, the service is able to monitor the user calendar because the service can register (e.g., via communication 201) with the calendar service supporting the user calendar and receive updates to the user calendar in accordance with the protocols of that service, for example, where the service notifies (communication not shown) any application registered with the service that a change has been made to the calendar and, optionally, communicates that change (e.g., calendar information 203) as part of the notification. When the automatic time blocking system 200 only receives a notification of the change, the system 200 may, in response to the notification, request (e.g., via communication 202) the calendar service for the user's calendar information (and the information received via communication 203).

In some cases, the service polls the calendar service regularly to identify any updates to the user calendar. The system 200 can poll the calendar service by requesting information from the storage resource 120 (through, for example, communication 202 with the calendar server 210). The request (202) can include a start date, an end date, and a calendar identifier (Cid). In some cases, there are no parameters passed as part of the request (or only some parameters are passed) and the server 210 uses default settings such as “this month” and/or “default calendar” to pull the appropriate start date, end date, and calendar. The calendar service identifies the calendar from the calendar id in the structured data stored at the calendar storage 120 and populates the returned calendar with the events associated with that calendar id (e.g., from an event database). In some cases (not shown), the system 200 communicates with the client calendar application to check the user's calendar for whether the threshold has been satisfied.

FIG. 3 illustrates an example storage structure. Calendar storage 120 may be embodied as storage resource 320, which can store a table (or other data structure) of calendars. For example, a calendar database 322 can store a calendar id, the name of the calendar, a color (for the user interface), access/share permissions of users, and any other properties of the calendar object. The storage resource 320 can also store a table (or other data structure) of events. For example, an event database 324 can provide a set of events. Each event can include an event identifier, the calendar id of the calendar where the event lives, a subject, an event date/time, and any other information.

Returning to FIG. 2B, upon determining that the time period in the user calendar has characteristics satisfying the threshold (e.g., from operation 257), the service automatically, without user interaction, requests (258) the calendar service to add a block of time as an appointment event on a day within the time period in the user calendar (e.g., schedules an event 204). Of course, other actions (and modifications to the user calendar such as, but not limited to, removing and moving appointments) may be requested by the time blocking service to the calendar service. If one of the meetings cancels, and the meetings are fewer than threshold hours, the service may either leave the me time as is, or remove the me time to allow for meetings to be scheduled. This can be a user setting.

Until the threshold is satisfied, other users having access to the user's calendar can see the time as available. Once the threshold is satisfied, the time is blocked out and can be indicated as busy (or other designation) to those having access to the user's calendar. In some cases, if another user has full access to the user's calendar—based on the shared calendar settings, the other use can see that the time is blocked as me-time.

The service is not directed to reprioritizing or moving around calendar items; rather, the service stops new meetings from appearing on a user's calendar or at least conveys to other people viewing the calendar, that the time is full.

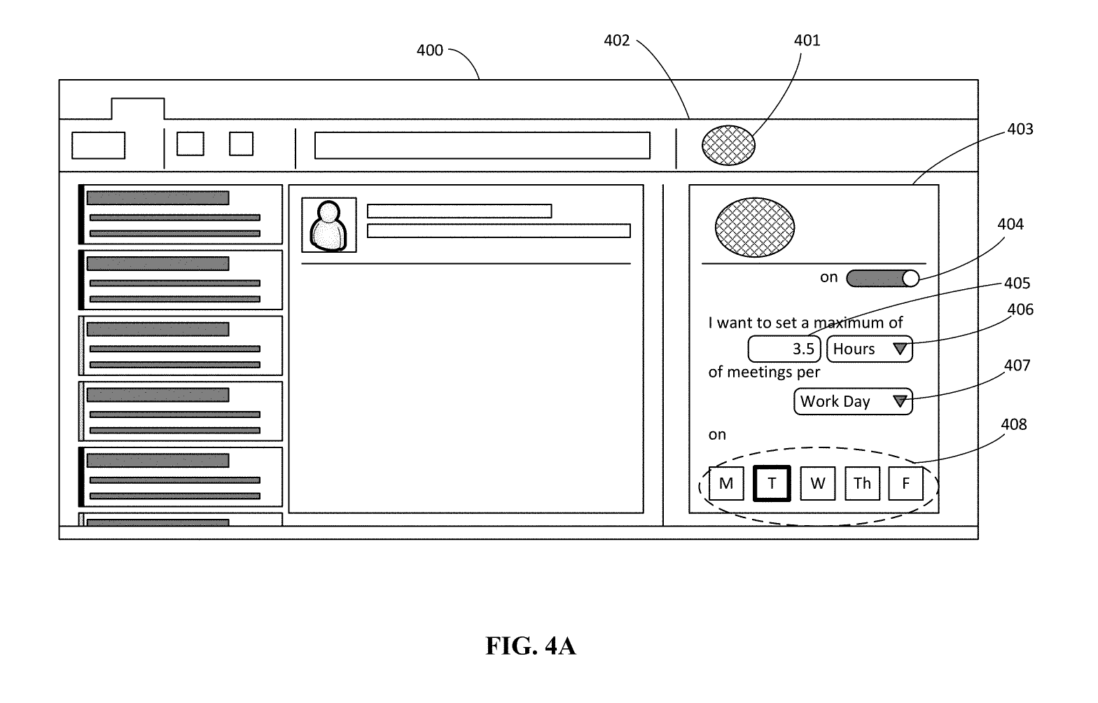

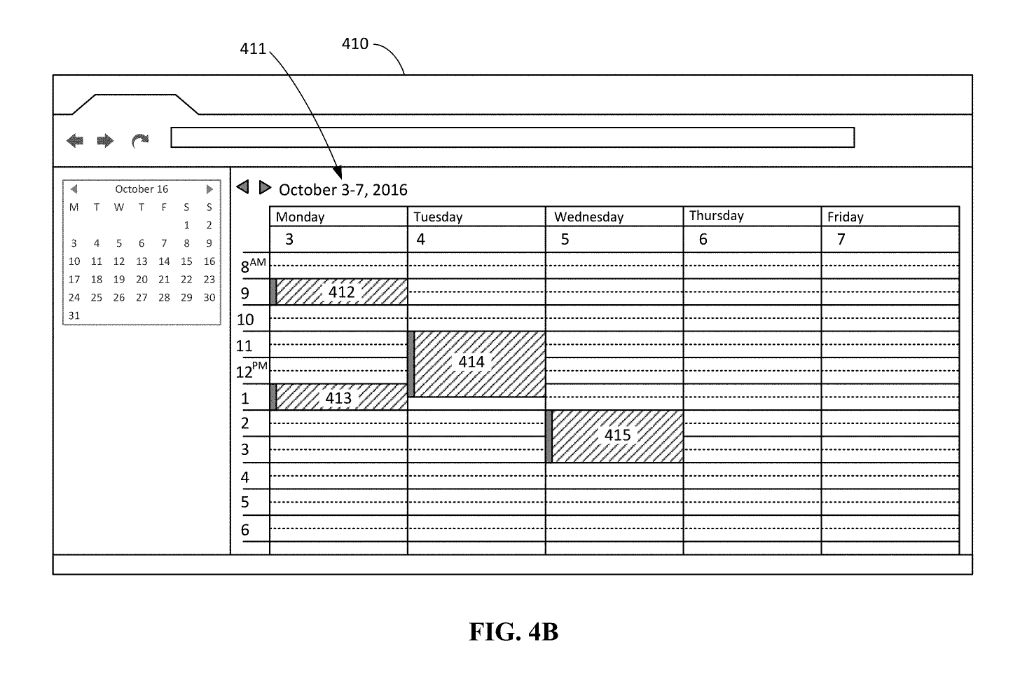

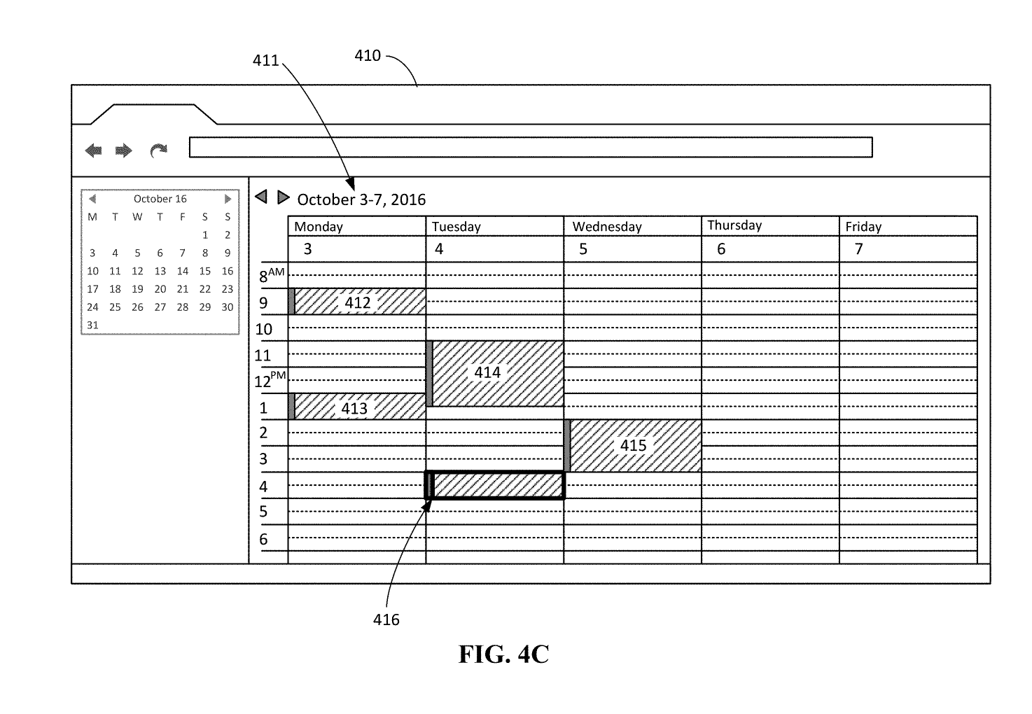

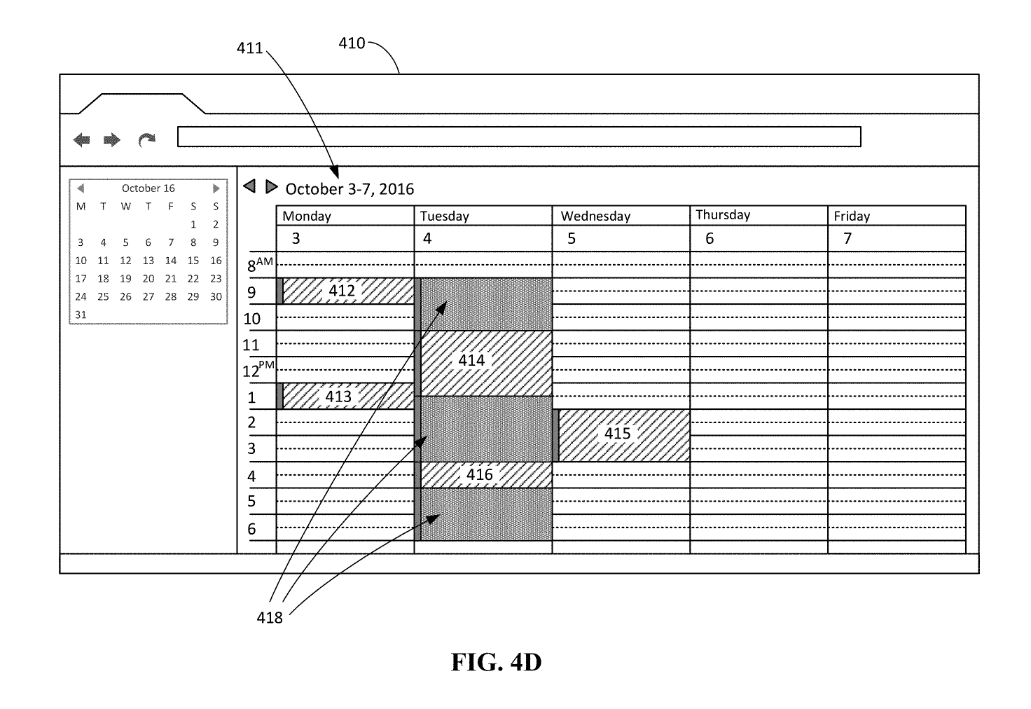

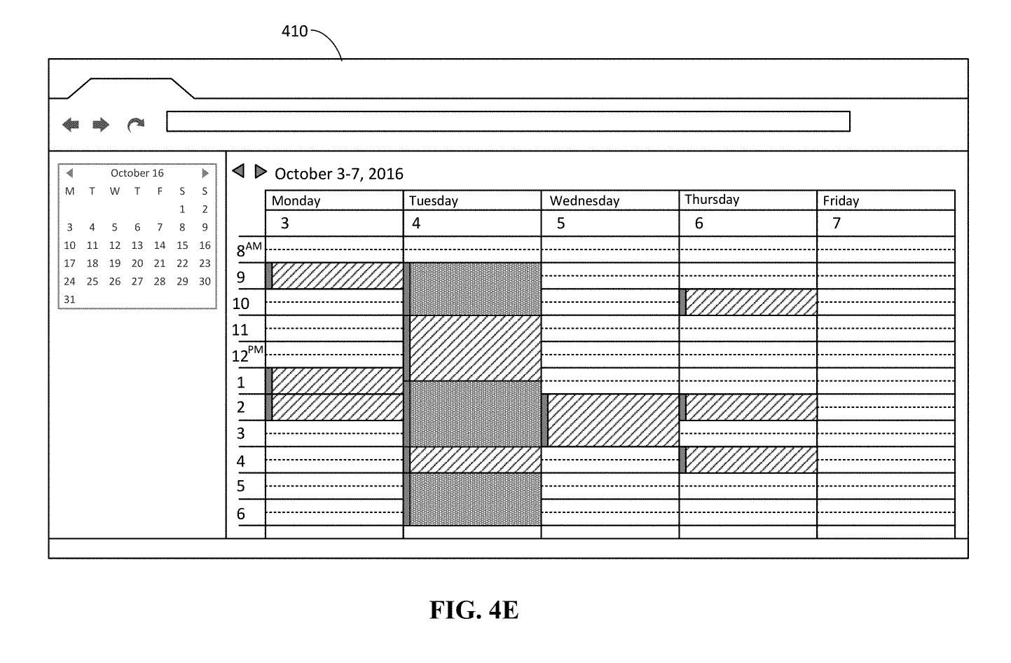

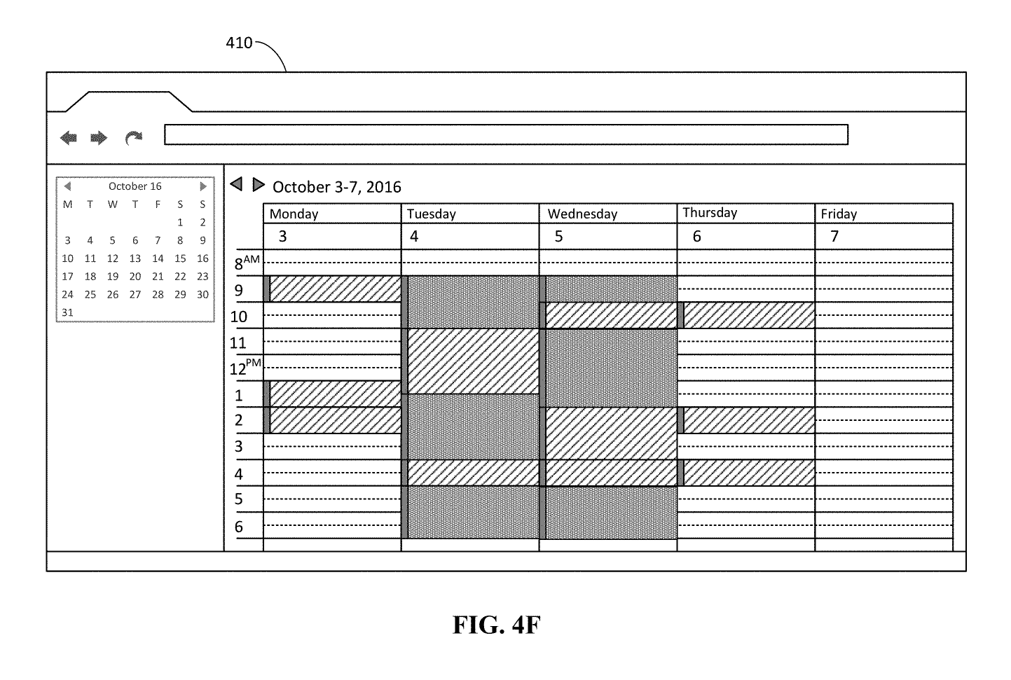

FIGS. 4A-4F provide a series of representative views of a graphical user interfaces for email and calendar applications illustrating an example scenario where an automatic time blocking feature is activated. Referring to FIG. 4A, a user may have downloaded a plug-in for the automatic time blocking feature for their email application. Of course, the plug-in could be part of a mobile application or be on a website instead of being in the email application. In the representative graphical user interface 400 that may be displayed on the user's computing device, the graphical user interface 400 may include a feature icon 401 on a menu 402 of the graphical user interface 400. A window 403 can be provided when the feature icon 401 is selected that permits the user to enter user settings. In this example, the window 403 reflects selected user settings of turning on the service (e.g., via input field 404), setting a maximum of 3.5 hours (via number input field 405 and unit of time input field 406) of meetings per work day (via time period input field 407) on Tuesday (via day selection input field 408). Of course, more or fewer input fields may be provided. The plug-in sends the user settings and calendar identifier for the user to the automatic time blocking service.

The user may view their calendar via, for example, the email application such as shown in FIG. 4A or via a web application such as shown in the graphical user interface illustrated in FIG. 4B. Referring to FIGS. 4B and 4C, in a graphical user interface 410 of a web application, the user may access a calendar view 411 showing meetings they have accepted. As the user accepts more meetings, their calendar view 411 reflects the accepted meetings as blocked out time (e.g., 412, 413, 414, 415).

The service, which is monitoring the user's calendar based on the user settings, calculates the number of hours of meetings for, in this case, Tuesday, and determines whether a Tuesday has hit the threshold of 3.5 hours of meetings for a workday. For example, as shown in FIG. 4C, the user is shown as having accepted an hour meeting 416 on Tuesday, which already has a 2.5 hour meeting 414 on the calendar. The service detects the addition of the meeting 416 and, as a result of a determination that the day has characteristics satisfying the threshold (at least 3.5 hours of meetings), the service automatically books the rest of the day, for example by requesting the calendar service to include additional events (e.g., appointments) for the times remaining in that work day (between existing events).

Referring to FIG. 4D, the user's calendar view would automatically reflect the additional ‘busy’ or ‘blocked out’ time 418 set by the service. Advantageously, the service does not fill up the day until after the critical threshold is met so a user can continue to accept meetings (and other users see the time as available) until the threshold for that day is met.

For example, if the user settings indicated that the user would like the maximum of 3.5 hours of meetings per each work day, as the user's calendar continues to fill up as shown in FIGS. 4E and 4F, the service is either notified by the calendar service that there has been a change in the user's calendar or polls the calendar service regularly to identify whether there has been a change and calculates the number of hours of meetings already accepted on each day. When the total number of hours (or other unit of time) satisfies the threshold, the service requests the calendar service to fill the remaining time with appointments to block out the time for the user.

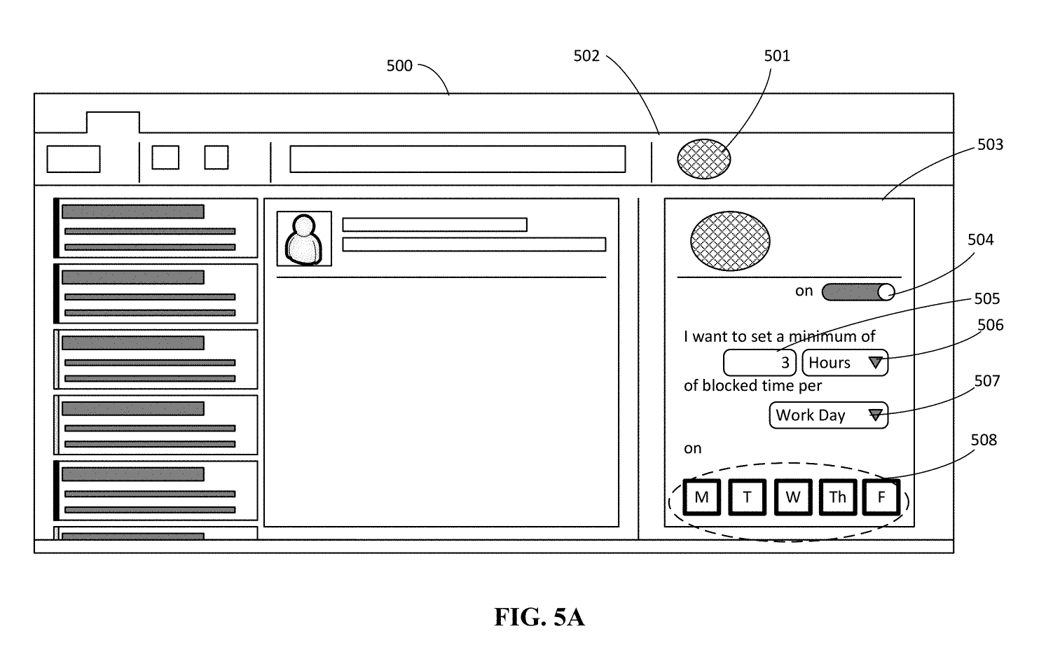

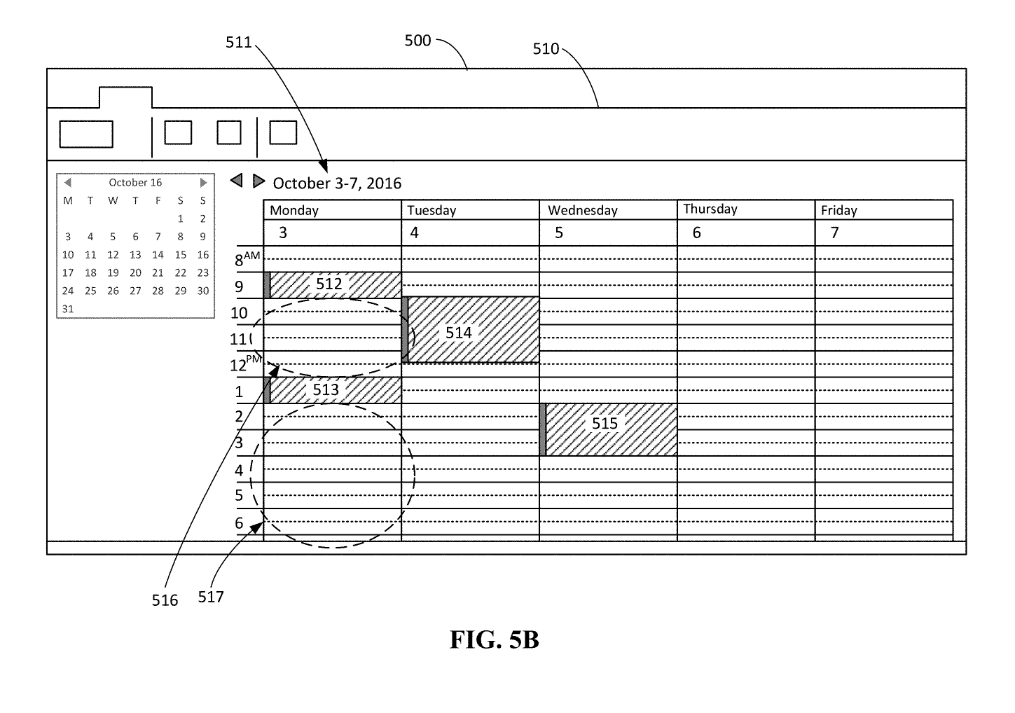

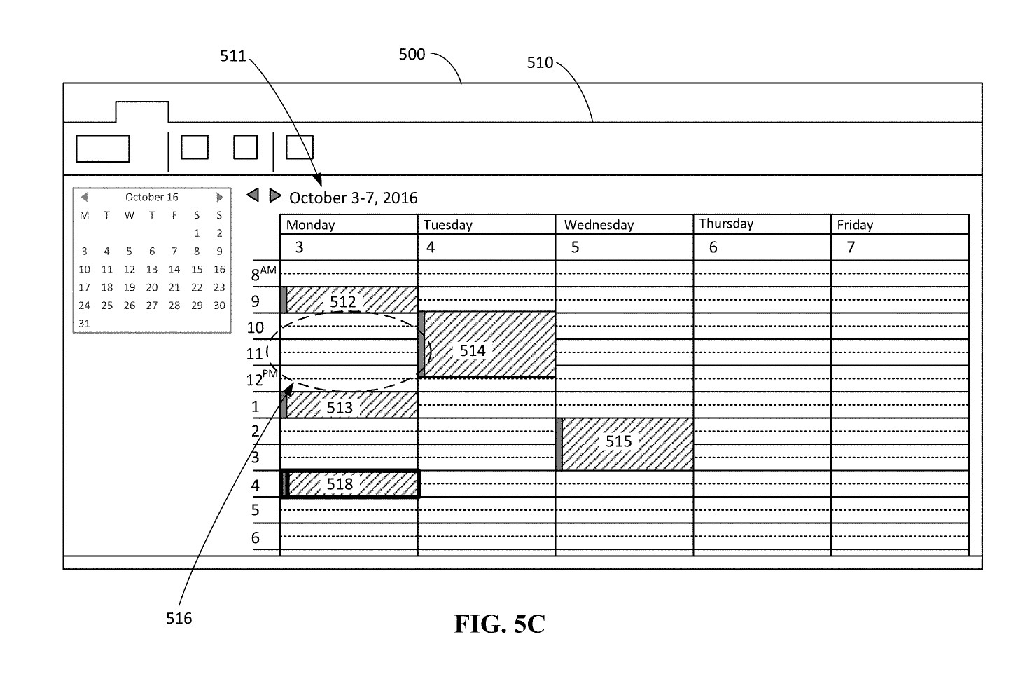

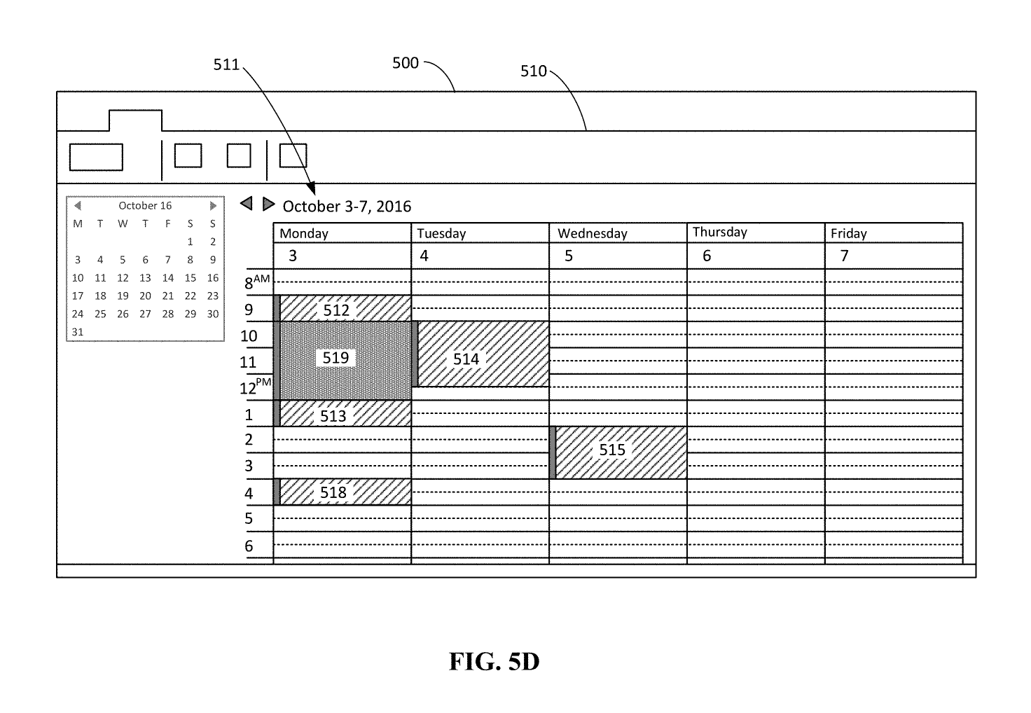

FIGS. 5A-5D provide a series of representative views of a graphical user interfaces for email and calendar applications illustrating an example scenario where another automatic time blocking feature is activated. Referring to FIG. 5A, a user may have downloaded a plug-in for the automatic time blocking feature for their email application. Of course, the plug-in could be part of a mobile application or be on a website instead of being in the email application. In the representative graphical user interface 500 that may be displayed on the user's computing device, the graphical user interface 500 may include a feature icon 501 on a menu 502 of the graphical user interface 500. A window 503 can be provided when the feature icon 501 is selected that permits the user to enter user settings. In this example, the window 503 reflects selected user settings of turning on the service (e.g., via input field 504), setting a minimum of 3 hours (via number input field 505 and unit of time input field 506) of meetings per work day (via time period input field 507) for each work day of the week (via day selection input field 508). Of course, more or fewer input fields may be provided. In some cases, another field or command may be provided for the user to select whether there is a minimum block of desired time or a maximum number of meeting hours or both. Other advanced settings may be set through menu(s) (not shown). The plug-in sends the user settings and calendar identifier for the user to the automatic time blocking service.

The user may view their calendar via, for example, the email application (with a calendar view window) or via a web application. For example, as shown in FIG. 5B, a user may view their calendar in a calendar view window 510 of the graphical user interface 501 of the email application.

Referring to FIGS. 5B and 5C, in the calendar view window 510, the user may access a calendar view 511 showing meetings they have accepted. As the user accepts more meetings, their calendar view 511 reflects the accepted meetings as blocked out time (e.g., 512, 513, 514, 515).

The service, which is monitoring the user's calendar based on the user settings, calculates the number of hours remaining between calendar events and determines whether there is enough time remaining for a desired block of time on each day. For example, the service, in this case, would see that Monday has a first block 516 of remaining time of 3 hours between meeting 512 and meeting 513 and has a second block 517 of remaining time of 5 hours (assuming a work day of 9 am to 7 pm) after meeting 513 that satisfy the threshold of a minimum of a 3 hour contiguous block of time. Similarly, the service can perform the calculations for the rest of the days.

Depending on the settings, the service may treat the remaining time hour blocks in various ways. In one case, the service begins calculating hours from the start of the work day to the beginning of a first scheduled meeting to see if there are at least three hours remaining. A first three hours would be assigned as a block and the remaining time to that first meeting would count as a second block if there would be another three hours. The service would then calculate from the end of the scheduled meeting until the setting of 3 hours is identified from that remaining time to determine another block of time. If this approach was used in the case shown in FIG. 5B, block 517 would be from 2 pm until 5 pm instead of from 2 pm to 7 pm.

When there is only one 3 hour block of time remaining in the day, the service can book that block of time, for example, by requesting the calendar service to include additional events (e.g., appointments) for the 3 hour block (or in some cases the full remaining block between two events or between the start or end of day and the first or last meeting).

In the example illustrated in FIG. 5B, two blocks of time are available on Monday, and therefore, no automatic time blocking takes place. However, as shown in FIG. 5C, when a user accepts meeting 518 on Monday, only a single block, block 516 remains on that day. The service detects the addition of the meeting 518 and, as a result of a determination that the day has characteristics satisfying the threshold (a 3 hour contiguous block of remaining time), the service automatically books the block 516, for example by requesting the calendar service to include an additional event (e.g., appointment) for 10 am to 1 pm on Monday.

Referring to FIG. 5D, the user's calendar view would automatically reflect the additional ‘busy’ or ‘blocked out’ time 519 set by the service. Advantageously, the service does not block out the time until after the critical threshold is met so a user can continue to accept meetings (and other users see the time as available) until the threshold for that day is met.

As mentioned above, various advanced settings (user- or design-based) may be available. Some examples of advanced settings include how to handle when a meeting is deleted on a day having time automatically blocked by the service; how to handle different types of meetings (e.g., whether to count appointments scheduled by user as part of the meeting total); and being able to indicate blocks of time (or certain meetings) that will not influence the automatic time blocking. Filters and advanced settings may be applied retroactively to a user's calendar. At any time, a user may disable the service and undo any changes made by the service.

FIGS. 6A and 6B present block diagrams illustrating components of systems that may be used to implement the systems and techniques described herein.

Referring to FIG. 6A, system 600 may represent a computing device such as, but not limited to, a personal computer, a tablet computer, a reader, a mobile device, a personal digital assistant, a wearable computer (e.g., in the form of a watch, glasses, apparel), a smartphone, a laptop computer (notebook or netbook), a gaming device or console, a desktop computer, or a smart television. Accordingly, more or fewer elements described with respect to system 600 may be incorporated to implement a particular computing device.

System 600, for example, includes a processing system 605 of one or more processors to transform or manipulate data according to the instructions of software 610 stored on a storage system 615. Examples of processors of the processing system 605 include general purpose central processing units, application specific processors, and logic devices, as well as any other type of processing device, combinations, or variations thereof.

Storage system 615 may comprise any computer readable storage media readable by the processing system 605 and capable of storing software 610 including the calendar application 620 and/or browsing application 625.

Storage system 615 may include volatile and nonvolatile, removable and non-removable media implemented in any method or technology for storage of information, such as computer readable instructions, data structures, program modules, or other data. Examples of storage media include random access memory, read only memory, magnetic disks, optical disks, CDs, DVDs, flash memory, virtual memory and non-virtual memory, magnetic cassettes, magnetic tape, magnetic disk storage or other magnetic storage devices, or any other suitable storage media. As defined herein, in no case is a storage medium a propagated signal or carrier wave.

Storage system 615 may be implemented as a single storage device but may also be implemented across multiple storage devices or sub-systems co-located or distributed relative to each other. Storage system 615 may include additional elements, such as a controller, capable of communicating with processor 605.

The software 610 can include an operating system 618 and application programs such as a calendar application 620 and/or web browsing application 625. A plug-in 621 for the described automatic time blocking service may be included as well. A device operating system 618 generally controls and coordinates the functions of the various components in the computing device, providing an easier way for applications to connect with lower level interfaces like the networking interface. Non-limiting examples of operating systems include Windows® from Microsoft Corp., Apple® iOS™ from Apple, Inc., Android® OS from Google, Inc., and the Ubuntu variety of the Linux OS from Canonical.

It should be noted that the operating system 618 may be implemented both natively on the computing device and on software virtualization layers running atop the native device operating system (OS). Virtualized OS layers, while not depicted in FIG. 6A, can be thought of as additional, nested groupings within the operating system space, each containing an OS, application programs, and APIs.

The system can further include user interface system 630, which may include input/output (I/O) devices and components that enable communication between a user and the system 600. User interface system 630 can include input devices such as a mouse, track pad, keyboard, a touch device for receiving a touch gesture from a user, a motion input device for detecting non-touch gestures and other motions by a user, a microphone for detecting speech, and other types of sensors and input devices and their associated processing elements capable of receiving user input.

The user interface system 630 may also include output devices such as display screen(s), speaker(s), haptic devices for tactile feedback, and other types of output devices. In certain cases, the input and output devices may be combined in a single device, such as a touchscreen display which both depicts images and receives touch gesture input from the user. Visual output may be depicted on the display in myriad ways, presenting graphical user interface elements, text, images, video, notifications, virtual buttons, virtual keyboards, or any other type of information capable of being depicted in visual form.

The user interface system 630 may also include user interface software and associated software (e.g., for graphics chips and input devices) executed by the OS in support of the various user input and output devices. The associated software assists the OS in communicating user interface hardware events to application programs using defined mechanisms. The user interface system 630 including user interface software may support a graphical user interface, a natural user interface, or any other type of user interface. For example, the calendar views described herein may be presented through user interface system 630.

Communications interface 640 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS 618, which informs applications of communications events when necessary.

It should be noted that many elements of system 600 may be included in a system-on-a-chip (SoC) device. These elements may include, but are not limited to, the processing system 605, a communications interface 640, and even elements of the storage system 615.

Certain aspects described herein may be carried out on a system such as shown in FIG. 6B. Referring to FIG. 6B, system 650 may be implemented within a single computing device or distributed across multiple computing devices or sub-systems that cooperate in executing program instructions. The system 650 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 650 can include a processing system 655, which may include one or more processors and/or other circuitry that retrieves and executes software 660 from storage system 665. Processing system 655 may be implemented within a single processing device but may also be distributed across multiple processing devices or sub-systems that cooperate in executing program instructions.

Examples of processing system 655 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

As with storage system 615 of FIG. 6A, storage system 665 can include any computer readable storage media readable by processing system 655 and capable of storing software 660. Storage system 665 may be implemented as a single storage device but may also be implemented across multiple storage devices or sub-systems co-located or distributed relative to each other. Storage system 665 may include additional elements, such as a controller, capable of communicating with processing system 655.

In some cases, storage system 665, when part of a system implementing a calendar service, includes one or more storage resources in which calendar information is stored. In some cases, storage system 665, when part of a system implementing an automatic time blocking service, includes one or more storage resources in which user settings and user calendar information is stored.

Software 660 may be implemented in program instructions and among other functions may, when executed by system 650 in general or processing system 655 in particular, direct the system 650 or processing system 655 to operate as described herein for storing and retrieving calendar events. Software 660 may provide program instructions that embody a service 670 implementing the calendar service or the described automatic time blocking service, or both, depending on the system being embodied by system 650.

Software 660 may also include additional processes, programs, or components, such as operating system software or other application software. Software 660 may also include firmware or some other form of machine-readable processing instructions executable by processing system 655.

System 650 may represent any computing system on which software 660 may be staged and from where software 660 may be distributed, transported, downloaded, or otherwise provided to yet another computing system for deployment and execution, or yet additional distribution.

In embodiments where the system 650 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 675 may be included, providing communication connections and devices that allow for communication between system 650 and other computing systems (not shown) over a communication network or collection of networks (not shown) or the air.

It should be noted that many elements of system 650 may be included in a SoC device. These elements may include, but are not limited to, the processing system 655, the communications interface 675, and even elements of the storage system 665.

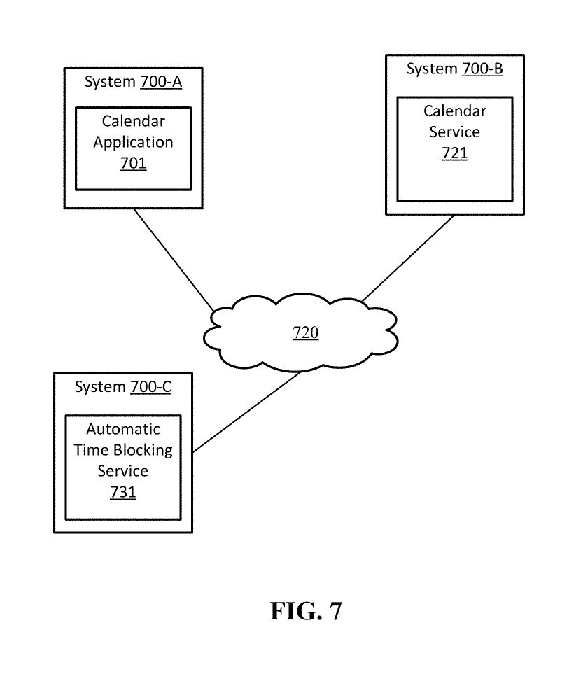

FIG. 7 illustrates an example system architecture in which the described systems and techniques may be carried out. Referring to FIG. 7, a calendar application 701 may be implemented on a computing system 700-A such as described with respect to system 600 of FIG. 6A. The user of the calendar application 701 may utilize the application to create, edit, or view a calendar event.

Calendar application 701 may communicate over network 720 with associated calendar service(s) 721 embodied on system 700-B, which is a particular instance of system 650 described in FIG. 6B. Calendar service(s), of which there may be several types, vendors or providers, and access methods, may be embodied in data structures and processing functions allowing accessibility and interchange with calendar applications 701.

Calendar application 701, when incorporating a plug-in for the automatic time blocking feature, may communicate over network 720 with automatic time blocking service 731 embodied on system 700-C, which is a particular instance of system 650 described in FIG. 6B, to initiate the automatic time blocking service by at least providing the calendar information (e.g., calendar identifier) and one or more user settings.

Communication between calendar application 701 and the automatic time blocking service 731 and communication between calendar service 721 and automatic time blocking service 731 may be carried out using APIs to send requests and receive information.

An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. An API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic.

The API-calling component may be a local component (i.e., on the same data processing system as the API-implementing component) or a remote component (i.e., on a different data processing system from the API-implementing component) that communicates with the API-implementing component through the API over a network. An API is commonly implemented over the Internet such that it consists of a set of Hypertext Transfer Protocol (HTTP) request messages and a specified format or structure for response messages according to a REST (Representational state transfer) or SOAP (Simple Object Access Protocol) architecture.

The network 720 can include, but is not limited to, a cellular network (e.g., wireless phone), a point-to-point dial up connection, a satellite network, the Internet, a local area network (LAN), a wide area network (WAN), a WiFi network, an ad hoc network, an intranet, an extranet, or a combination thereof. The network may include one or more connected networks (e.g., a multi-network environment) including public networks, such as the Internet, and/or private networks such as a secure enterprise private network.

It should be understood that the examples and embodiments described herein are for illustrative purposes only and that various modifications or changes in light thereof will be suggested to persons skilled in the art and are to be included within the scope of the claims.

Certain aspects of the invention provide the following non-limiting examples.

### EXAMPLE 1

A system for automatic time blocking for calendar applications, comprising: a processing system; a storage system; instructions for automatic time blocking for calendar applications stored on the storage system, the instructions directing the processing system to at least: receive information identifying a user calendar and a user setting at least regarding an amount of time for an event type within a time period; set a threshold according to the user settings; monitor the user calendar, via communication with a calendar service, to determine whether the time period in the user calendar has characteristics satisfying the threshold; and upon determining that the time period in the user calendar has characteristics satisfying the threshold, automatically, without user interaction, request the calendar service to modify the user calendar.

### EXAMPLE 2

The system of example 1, wherein the event type is a meeting item.

### EXAMPLE 3

The system of example 2, wherein the instructions that direct the processing system to monitor the user calendar to determine whether the day in the user calendar has characteristics satisfying the threshold direct the processing system to at least: receive updates from the calendar service each time a new meeting item is added to a day of the user calendar; calculate a total number of hours of meeting items in that day; and determine whether the total number of hours of meeting items in that day satisfy the threshold of total amount of time for meetings in the time period.

### EXAMPLE 4

The system of example 2 or 3, wherein the request to modify the user calendar comprises a request to add a block of time as the appointment event to the day in the user calendar, the block of time being added for any time not already indicated as having the meeting item.

### EXAMPLE 5

The system of any of examples 1-4, wherein the event type is a block of contiguous time without a meeting item.

### EXAMPLE 6

The system of example 5, wherein the request to modify the user calendar comprises a request to add a block of time as the appointment event to the day in the user calendar, the block of time having a length of time corresponding to the block of contiguous time without the meeting item.

### EXAMPLE 7

The system of example 5 or 6, wherein the instructions that direct the processing system to monitor the user calendar to determine whether the day in the user calendar has characteristics satisfying the threshold direct the processing system to at least: receive updates from the calendar service each time a new meeting item is added to a day of the user calendar; and identify whether there is a block of contiguous time without a meeting item that satisfies a length of time for the block of contiguous time without the meeting item.

### EXAMPLE 8

A computer-implemented method comprising: receiving, at a computing system, information identifying a user calendar and a user setting at least regarding an amount of time for an event type within a time period; setting, by a processing system of the computing system, a threshold according to the user settings; monitoring the user calendar, via communication with a calendar service, to determine whether the time period in the user calendar has characteristics satisfying the threshold; and upon determining that the time period in the user calendar has characteristics satisfying the threshold, automatically, without user interaction, requesting the calendar service to add a block of time as an appointment event on a day within the time period in the user calendar.

### EXAMPLE 9

The method of example 8, wherein the event type is a meeting item.

### EXAMPLE 10

The method of example 9, wherein monitoring the user calendar to determine whether the day in the user calendar has characteristics satisfying the threshold comprises: receiving updates from the calendar service each time a new meeting item is added to a day of the user calendar; calculating a total number of hours of meeting items in that day; and determining whether the total number of hours of meeting items in that day satisfy the threshold of total amount of time for meetings in the time period.

### EXAMPLE 11

The method of example 9, wherein the request to add a block of time as the appointment event to the day in the user calendar comprises a request to add the appointment event for any time not already indicated as having the meeting item.

### EXAMPLE 12

The method of any of examples 8-11, wherein the event type is a block of contiguous time without a meeting item.

### EXAMPLE 13

The method of example 12, Wherein the request to add the block of time as the appointment event to the day in the user calendar comprises a request to add the appointment event in a time period of the day having a length of time corresponding to the block of contiguous time without the meeting item.

### EXAMPLE 14

The method of any of examples 12-13, wherein monitoring the user calendar to determine whether the day in the user calendar has characteristics satisfying the threshold comprises: receiving updates from the calendar service each time a new meeting item is added to a day of the user calendar; and identifying whether there is a block of contiguous time without a meeting item that satisfies a length of time for the block of contiguous time without the meeting item.

### EXAMPLE 15

One or more computer-readable storage media having instructions stored thereon that, when executed by a processing system, direct the processing system to at least: receive information identifying a user calendar and a user setting at least regarding an amount of time for an event type within a time period; set a threshold according to the user settings; monitor the user calendar, via communication with a calendar service, to determine whether the time period in the user calendar has characteristics satisfying the threshold; and upon determining that the time period in the user calendar has characteristics satisfying the threshold, automatically, without user interaction, request the calendar service to add a block of time as an appointment event on a day within the time period in the user calendar.

### EXAMPLE 16

The media of example 15, wherein the event type is a meeting item.

### EXAMPLE 17

The media of example 16, wherein the request to add a block of time as the appointment event to the day in the user calendar comprises a request to add the appointment event for any time not already indicated as having the meeting item.

### EXAMPLE 18

The media of any of examples 15-17, wherein the event type is a block of contiguous time without a meeting item.

### EXAMPLE 19

The media of example 18, wherein the request to add the block of time as the appointment event to the day in the user calendar comprises a request to add the appointment event in a time period of the day having a length of time corresponding to the block of contiguous time without the meeting item.

### EXAMPLE 20

The media of any of examples 18-19, wherein the instructions that direct the processing system to monitor the user calendar to determine whether the day in the user calendar has characteristics satisfying the threshold direct the processing system to at least: receive updates from the calendar service each time a new meeting item is added to a day of the user calendar; and identify whether there is a block of contiguous time without a meeting item that satisfies a length of time for the block of contiguous time without the meeting item.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A system for automatic time blocking for calendar applications, comprising:
a processing system;
a storage system;
instructions for automatic time blocking for calendar applications stored on the storage system, the instructions directing the processing system to at least:
receive information identifying a user calendar and a user setting at least regarding an amount of time for an event type within a time period;
set a threshold according to the user settings;
monitor the user calendar, via communication with a calendar service, to determine whether the time period in the user calendar has characteristics satisfying the threshold; and
upon determining that the time period in the user calendar has characteristics satisfying the threshold, automatically, without user interaction, request the calendar service to modify the user calendar.

2. The system of claim 1, wherein the event type is a meeting item.

3. The system of claim 2, wherein the instructions that direct the processing system to monitor the user calendar to determine whether the day in the user calendar has characteristics satisfying the threshold direct the processing system to at least:
receive updates from the calendar service each time a new meeting item is added to a day of the user calendar;
calculate a total number of hours of meeting items in that day; and
determine whether the total number of hours of meeting items in that day satisfy the threshold of total amount of time for meetings in the time period.

4. The system of claim 2, wherein the request to modify the user calendar comprises a request to add a block of time as the appointment event to the day in the user calendar, the block of time being added for any time not already indicated as having the meeting item.

5. The system of claim 1, wherein the event type is a block of contiguous time without a meeting item.

6. The system of claim 5, wherein the request to modify the user calendar comprises a request to add a block of time as the appointment event to the day in the user calendar, the block of time having a length of time corresponding to the block of contiguous time without the meeting item.

7. The system of claim 5, wherein the instructions that direct the processing system to monitor the user calendar to determine whether the day in the user calendar has characteristics satisfying the threshold direct the processing system to at least:
receive updates from the calendar service each time a new meeting item is added to a day of the user calendar; and
identify whether there is a block of contiguous time without a meeting item that satisfies a length of time for the block of contiguous time without the meeting item.

8. A computer-implemented method comprising:
receiving, at a computing system, information identifying a user calendar and a user setting at least regarding an amount of time for an event type within a time period;
setting, by a processing system of the computing system, a threshold according to the user settings;
monitoring the user calendar, via communication with a calendar service, to determine whether the time period in the user calendar has characteristics satisfying the threshold; and
upon determining that the time period in the user calendar has characteristics satisfying the threshold, automatically, without user interaction, requesting the calendar service to add a block of time as an appointment event on a day within the time period in the user calendar.

9. The method of claim 8, wherein the event type is a meeting item.

10. The method of claim 9, wherein monitoring the user calendar to determine whether the day in the user calendar has characteristics satisfying the threshold comprises:
receiving updates from the calendar service each time a new meeting item is added to a day of the user calendar;
calculating a total number of hours of meeting items in that day; and
determining whether the total number of hours of meeting items in that day satisfy the threshold of total amount of time for meetings in the time period.

11. The method of claim 9, wherein the request to add a block of time as the appointment event to the day in the user calendar comprises a request to add the appointment event for any time not already indicated as having the meeting item.

12. The method of claim 8, wherein the event type is a block of contiguous time without a meeting item.

13. The method of claim 12, Wherein the request to add the block of time as the appointment event to the day in the user calendar comprises a request to add the appointment event in a time period of the day having a length of time corresponding to the block of contiguous time without the meeting item.

14. The method of claim 12, wherein monitoring the user calendar to determine whether the day in the user calendar has characteristics satisfying the threshold comprises:
receiving updates from the calendar service each time a new meeting item is added to a day of the user calendar; and
identifying whether there is a block of contiguous time without a meeting item that satisfies a length of time for the block of contiguous time without the meeting item.

15. One or more computer-readable storage media having instructions stored thereon that, when executed by a processing system, direct the processing system to at least:
receive information identifying a user calendar and a user setting at least regarding an amount of time for an event type within a time period;
set a threshold according to the user settings;
monitor the user calendar, via communication with a calendar service, to determine whether the time period in the user calendar has characteristics satisfying the threshold; and
upon determining that the time period in the user calendar has characteristics satisfying the threshold, automatically, without user interaction, request the calendar service to add a block of time as an appointment event on a day within the time period in the user calendar.

16. The media of claim 15, wherein the event type is a meeting item.

17. The media of claim 16, wherein the request to add a block of time as the appointment event to the day in the user calendar comprises a request to add the appointment event for any time not already indicated as having the meeting item.

18. The media of claim 15, wherein the event type is a block of contiguous time without a meeting item.

19. The media of claim 18, wherein the request to add the block of time as the appointment event to the day in the user calendar comprises a request to add the appointment event in a time period of the day having a length of time corresponding to the block of contiguous time without the meeting item.

20. The media of claim 18, wherein the instructions that direct the processing system to monitor the user calendar to determine whether the day in the user calendar has characteristics satisfying the threshold direct the processing system to at least:
receive updates from the calendar service each time a new meeting item is added to a day of the user calendar; and
identify whether there is a block of contiguous time without a meeting item that satisfies a length of time for the block of contiguous time without the meeting item.
